(19) United States
(12) Patent Application Publication
(10) Pub. No.: US 2023/0252887 A1
(43) Pub. Date: Aug. 10, 2023

(54) METHOD AND DEVICE FOR OPERATING AN INFRASTRUCTURE SENSOR SYSTEM

(71) Applicant: Robert Bosch GmbH, Stuttgart (DE)

(72) Inventors: Tobias Frye, Braunschweig (DE); Sebastian Nusser, Hildesheim (DE); Thomas Hansen, Hildesheim (DE)

(21) Appl. No.: 18/165,484

(22) Filed: Feb. 7, 2023

(30) Foreign Application Priority Data
Feb. 8, 2022 (DE) 10 2022 201 280.1

(51) Int. Cl. G08C 25/00; G01P 1/07; G06T 7/246; G06T 7/269

(52) U.S. Cl. CPC G08C 25/00; G01P 1/07; G06T 7/248; G06T 7/269; G06T 2207/30244

(57) ABSTRACT

A method for operating an infrastructure sensor system, wherein the infrastructure sensor system comprises a plurality of networked infrastructure sensors arranged on a shared mounting device. First, data are transmitted to a sway estimation module by at least one of the infrastructure sensors, wherein the data comprise at least pre-processed data, for example environmental information and/or current measurement data, in particular raw data, detected by the respective infrastructure sensor. The transmitted data are further processed in the next step and the sway estimation module determines therefrom a motion function for the mounting device. Based on the motion function, correction information, for example for at least one of the infrastructure sensors, is now determined by the sway estimation module. The correction information and/or motion function can now be provided for further use, for example, to the respective infrastructure sensors or to a central computing unit.

### CROSS REFERENCE

The present application claim the benefit under 35 U.S.C. § 119 of German Patent Application No. DE 10 2022 201 280.1 filed on Feb. 8, 2022, which is expressly incorporated herein by reference in its entirety.

### FIELD

The present invention relates to a method and device for operating an infrastructure sensor system. The present invention further relates to an infrastructure sensor system. The present invention further relates to a computer program.

### BACKGROUND INFORMATION

As in other technology areas, networking plays an increasingly important role in automotive applications. More and more vehicles have the ability to connect to other road users, infrastructure components (so-called roadside units or RSUs) or backend services in the cloud. In particular, recently, the connectivity of vehicles with systems on the infrastructure side is gaining in importance. Infrastructural systems can support vehicles in their driving tasks in that sensors on the roadside or data servers, for example, provide additional information that the on-board sensory system of the vehicle cannot generate itself or only to a limited extent.

German Patent Application No. DE 10 2020 118 412 A9 describes a safety monitoring system that uses data generated by a computing subsystem of an automated driving system, in order to realize a higher safety integrity level. Sensor fusion processes are used for this purpose, among other things. In principle, vehicles receive, for example, sensor data collected by external sensor devices or data containing observations or recommendations generated by other systems based on sensor data of these sensor devices and can use said data in sensor fusion, inference, route planning, and other tasks. The fusion of different sensor types thus allows, for example, the detection of objects, the determination of trajectories or an accurate location determination. In addition, a sensor fusion module can be utilized to control the use and processing of the various sensor inputs used by a machine learning engine and other modules of the in-vehicle processing system.

When a road infrastructure supports the driving task of a networked automated vehicle, it is necessary for the infrastructure sensors to be aware of their external influences and environment through calibration. This includes, for example, in which direction (consisting of roll, pitch and yaw angle) a specific infrastructure sensor (e.g., a camera) is oriented, how high the infrastructure sensor is above the ground, and the field of view of the infrastructure sensor. It has been found that masts on which the infrastructure sensors are mounted, for example, can sway or twist due to external influences (such as wind), thereby rendering an initial calibration inaccurate or erroneous. Such sensor masts can sway to different degrees and in different directions. This depends particularly on the environmental factors such as wind and the type and construction of the mast. For example, unilaterally anchored masts are more susceptible on the freely swinging side, whereas bilaterally anchored masts are less prone to sway, and, if they do sway, then they do so in the middle.

With infrastructure sensors configured as a camera, there are already possibilities for computationally compensating for such mechanical swaying, for example by the application of an optical flow algorithm. However, for an imaging infrastructure sensor that detects objects, for example, via machine learning and/or neural network, it can still be an issue to deal with mechanical swaying. For other sensor types, there is yet no known way of computationally compensating for such swaying in ongoing operation so that periodic recalibration is required for such infrastructure sensors.

### SUMMARY

An object of the present invention is to provide a method by which the influence of mechanical swaying of a mount of infrastructure sensors of an infrastructure sensor system in the ongoing operation of the infrastructure sensor system can be reliably determined and be taken into account in the measurements of the infrastructure sensor system.

A further object of the present invention is to provide an infrastructure system for detecting an environment of an infrastructure, in which the influence of mechanical swaying of a mount of infrastructure sensors of an infrastructure sensor system in the ongoing operation of the infrastructure sensor system can be reliably determined and be taken into account in the measurements of the infrastructure sensor system.

According to a first aspect of the present invention, a method for operating an infrastructure sensor system is proposed, wherein the infrastructure sensor system comprises a plurality of, in particular networked, infrastructure sensors, wherein the plurality of infrastructure sensors are arranged on a shared mounting device. According to an example embodiment of the present invention, the method comprises at least the following steps:

First, data are transmitted to a sway estimation module by at least one of the infrastructure sensors, wherein the data comprise at least pre-processed data, for example environmental information and/or current measurement data, in particular raw data, detected by the respective infrastructure sensor.

For example, it is possible to transmit data that include the position and orientation of the infrastructure sensor with periodic repetition and/or an initial position and a current motion vector. Alternatively or additionally, for example, data of an extrinsic calibration and/or raw data (e.g., video stream in the case of a camera) can be transmitted.

Specific environmental information can be conveyed by the respective infrastructure sensor. The detected environmental information can include, in particular, specific or prominent features of the environment. For example, the features can be line markings, if the infrastructure sensor is configured as a camera, or guardrails as locations or as a point cloud, if the infrastructure sensor is configured as a radar sensor. For example, environmental information that is present as camera data can be evaluated using the optical flow and thus a motion can be detected in the camera data.

The transmitted data are further processed in the next step and the sway estimation module determines from this a motion function for the mounting device. Based on the motion function, correction information, for example for at least one of the infrastructure sensors, is now determined by the sway estimation module. The correction information and/or the motion function can now be provided for further use, for example, to the respective infrastructure sensors or to a central computing unit.

The present invention thus makes it possible computationally to compensate for swaying even in sensor types which are themselves not able to do so. This is achieved by determining and further processing the information required for correcting the mechanical sway by means of at least one other infrastructure sensor, which in particular comprises a different sensor type. In a preferred embodiment of the present invention, information for correcting the mechanical sway through sensor fusion can be drastically improved even for infrastructure sensors that are themselves actually able to determine mechanical sway. In addition to subsequently correcting detected environmental data, the correction information can also be used to improve a confidence and/or accuracy of an infrastructure sensor. Thus, for example, if specific confidence or accuracy threshold values are exceeded or fallen short of, the data of individual infrastructure sensors or of all infrastructure sensors of the infrastructure system can be ignored or marked as erroneous.

It is further made possible to combine sensor types which themselves have a possibility of sway calculation with sensors that do not have their own sway calculation and also to integrate further external sensors into the system exclusively for detecting the sway.

In this context, a sway may be understood as any motion of the infrastructure sensor, which is caused, for example, by a motion and/or sway and/or rotation and/or vibration of the mounting device or part of the mounting device. The motion can be on any time scale, for example, wind can trigger an oscillation of the mounting device with periods of a few seconds or less than one second. However, markedly slower movements can also be triggered, for example by soil erosion or other effects, in which a noticeable deviation only occurs after periods of several days or longer.

In a preferred embodiment of the present invention, the pre-processed data comprise a position and/or an orientation and/or a motion vector according to a previously performed calibration and/or measurement data of the respective infrastructure sensor. Accordingly, the respective infrastructure sensor transmits data that already indicate a position and/or an orientation and/or a motion vector of the respective infrastructure sensor based on a current measurement and/or a calibration of the respective infrastructure sensor performed at an earlier point in time. This makes it possible to perform the processing the transmitted data and the determination of a motion function for the mounting device on the part of the sway estimation module and/or the ascertainment of correction information for at least one of the infrastructure sensors based on the motion function more efficiently. For example, no raw data have to be evaluated first.

In a preferred embodiment of the present invention, at least one of the infrastructure sensors of the infrastructure sensor system is configured as an environment sensor, in particular as an imaging sensor. A first sway estimate can be determined in this embodiment using the environmental information detected by the environment sensor, wherein the first sway estimate is provided to the sway estimation module and is used in determining the motion function and/or in ascertaining the correction information.

In particular, preferably, according to an example embodiment of the present invention, the processing of the data and the determination of the motion function for the mounting device can be performed by the sway estimation module additionally as a function of the first sway estimation. For example, the environmental information detected by an infrastructure sensor of the infrastructure sensor system configured as an environment sensor can comprise raw data, the sway estimation module being able to determine the first sway estimate based on the raw data. Alternatively, a first sway estimate can be determined based on environmental information and a second sway estimate can be specified based on raw data, and the motion function can be ascertained based on the first and/or the second sway estimate.

Particularly preferably, the first sway estimate can be determined by an optical flow analysis of image data that were detected by an infrastructure sensor configured as the imaging sensor. Optical flow analysis of image data is a proven method for ascertaining a motion from image data. A sway estimate of the respective infrastructure sensor can thus be determined particularly efficiently from this motion and a motion function can further be determined therefrom.

Alternatively, the first sway estimate can be determined by an analysis of landmarks or point clouds as compared to a map, which landmarks or point clouds were detected by an infrastructure sensor configured as an imaging sensor. For example, for camera sensors, sensor-specific landmarks, such as roadway markings, can be used for motion estimation. To this end, for example, during the initial calibration of a sensor or repeatedly a snapshot is taken of landmarks and stored as an image in a highly accurate map or as a digital twin. For example, in the case of a video sensor, these landmarks may be lines such as lane markings or reference objects such as trees or buildings, and in the case of a radar or lidar sensor, in particular, they may be reflections of stationary points such as guide posts or guardrails. Thereafter, the currently detected landmarks are continually compared with previously stored landmarks, thus calculating or improving the sway detection. The high accuracy map can alternatively or additionally be obtained from an external source and then be regarded like a sensor source belonging to the infrastructure system.

In the event that the data communicated by at least one of the infrastructure sensors to a sway estimation module comprise environmental information determined by the respective infrastructure sensor, the environmental information can comprise, in a further preferred embodiment of the present invention, object features of objects in the environment of the infrastructure sensor system. The object features can be provided to the sway estimation module and used in determining the motion function and/or in ascertaining the correction information. Thus, efficiently detected features of the environment are used to determine and correct a motion of the mounting device.

The motion function is based on a specific model assumption, for example, depending on the configuration of the mounting device, it can be assumed that a mast or a post deforms according to a specific function, for example, a polynomial function or a logarithmic function can be assumed for the function.

In the case of a transmission of raw data, for example a video stream from a camera, preferably a sway estimate can first be performed for the infrastructure sensor (e.g., the camera) supplying the raw data before the data are further processed with the information from the other infrastructure sensors.

In further processing, mathematical models, such as the calculation of differential equations, can be used to calculate a solution for a motion function ƒ(x) of a mast of the mounting device. This is done, for example, by drawing up different equations as follows:

f′(x₀)=0,f(x₀)=0,f′(x_end)=0

where x₀ is a supporting point when the mast is anchored on one side and x end indicates the free end of the mast. Further equations and/or boundary conditions can result from the evaluation of the transmitted data. For f(x), a model function can be specified, for example a polynomial function of the form f(x)=ax\hat{ }4+bx\hat{ }3+cx\hat{ }2+dx+e, where the function parameters a, b, c, d and e determine the function. The parameters can be ascertained by solving the set equation system. For example, parameter x indicates the position along a boom of a mast of the mounting device in a specific spatial direction.

In order for the system of equations to be solved, there must be more equations than unknowns. For example, more input data are required for a 3-dimensional determination of the sway, i.e. the motion function, than for a 2-dimensional determination. A 3D-sway calculation can advantageously significantly improve the accuracy of the method.

In a preferred embodiment of the present invention, the ascertained correction information comprises functional parameters of the motion function. By means of these functional parameters of the motion function and the model assumption for the motion function, an updated position and orientation and/or a motion vector for at least one of the infrastructure sensors can be determined. For example, the functional parameters (in the example above, the calculated values for a, b, c, d, and e) can be communicated to at least one of the infrastructure sensors. By means of the functional parameters and a known initial position and orientation of the respective infrastructure sensor, an updated position and orientation can now be determined and used as correction information. A particular advantage of this embodiment is that the motion function is not dependent on the respective sensor position, as it describes the motion of the mounting device itself. Thus, the motion function can be distributed equally to all infrastructure sensors. In particular, it can be sufficient to only transmit the ascertained functional parameters. By using multicast/broadcast mechanisms in IP-based networks, the network load can be kept small.

In a further preferred embodiment of the present invention, sensor-specific motion vectors can be determined from the motion function as correction information. By means of a motion vector, an updated position and/or orientation for at least one of the infrastructure sensors can be determined specifically for the respective infrastructure sensor. The sensor-specific motion vectors can be communicated to the respective infrastructure sensors so that the respective infrastructure sensor itself can determine an updated position and/or orientation for itself.

It can be generally provided in the context of the method according to the present invention that correction information is transmitted to at least one of the infrastructure sensors of the infrastructure sensor system so that measurement data of the infrastructure sensor can be corrected by the respective infrastructure sensor itself using the correction information.

For example, the respective infrastructure sensor can thereby update calibration information and take this into account when processing raw measurement data. Alternatively or additionally, the correction information can be made available to a central computing unit that also receives raw measurement data from at least one infrastructure sensor and that takes the correction information into account when processing the raw measurement data and/or when further processing pre-processed measurement data. For example, correction information as well as measurement data and/or environmental information are transmitted from the infrastructure sensors to the computing unit so that the computing unit can calculate an environmental model of the infrastructure sensor system using the correction information and the measurement data and/or environmental information.

For some infrastructure sensors, the computing unit as a central component makes the sway calculation according to the present invention possible in the first place, while for other infrastructure sensors, it can improve the sway calculation according to the present invention. After transmitting the calculated correction information or parameters of the ascertained motion function back to the infrastructure sensors, the latter can decide themselves (e.g., based on predefined threshold values) whether a computational compensation for the sway makes sense (e.g., in the case of rapid swaying in the wind) or whether a recalibration should be initiated, e.g., in the case of a slow twisting of a mast of the mounting device. Furthermore, preferably measurement data of an infrastructure sensor can be subsequently marked as inaccurate based on the correction information.

In a preferred embodiment of the present invention, a message comprising the data and the correction information is used for information exchange between an infrastructure sensor and the sway estimation module. The correction information here includes a motion function and/or parameters of the motion function and/or a sensor-specific motion vector and/or a corrected sensor position and/or a corrected sensor orientation. The message further includes information pertaining to the infrastructure sensor with which the information is exchanged, in particular, a sensor type of the infrastructure sensor and/or information as to whether the infrastructure sensor has its own sway detection and/or information as to whether the infrastructure sensor needs the correction information. Optionally, the message can include a signature and further optionally, a certificate for validating the signature. This increases the security of the exchange of information.

It can preferably be provided that the sway detection calculates a motion function or correction information not only for the present point in time, but rather uses the information available from the past and the present in order also to predict the future, that is, to predict the behavior of the mounting device in the nearer or more distant future with a certain probability. In this case, there is the possibility of a short-term prediction. This usually applies with a high probability since, for example, a mast that starts to sway in one direction usually also sways back afterward.

Furthermore, it is possible to make rougher, longer-term predictions using, for example, external weather sensor data, in that, for example, the behavior of the mounting function is known for specific wind speeds and/or wind directions. For such predictions, conventional filter methods can be used (e.g., Wiener filter, Kalman filter, . . . ) or machine learning or artificial intelligence approaches that can detect specific patterns in input data and sways.

Such predictions can in particular achieve the advantage of informing automated vehicles, which use information of the infrastructure sensor system for an automated travel function (infrastructure-supported automated driving “IAD”), that the infrastructure sensor system could shut down at a certain time (degradation) or operate only with reduced accuracy, or that areas are no longer reliably monitored. For example, an infrastructure sensor system whose sensors are disposed outside of a tunnel may have problems with strong winds, whereas sensors disposed within the tunnel are not impaired by the wind. Thus, the infrastructure sensor system may refuse to provide the IAD service to requesting vehicles, if appropriate.

According to a second aspect of the present invention, a device for operating an infrastructure sensor system is proposed. The device includes at least one sway estimation module and a communication unit configured to receive data, comprising pre-processed data and/or current measurement data, particularly raw data and/or environmental information, from infrastructure sensors of the infrastructure sensor system, wherein the infrastructure sensors are arranged on a shared mounting device. According to the present invention, the device is configured to perform a method according to the first aspect. To this end, the sway estimation module is configured to process the data received by the communication unit and to determine therefrom a motion function for the mounting device, to ascertain correction information for at least one of the infrastructure sensors based on the motion function, and to provide the correction information and/or the motion function.

According to a third aspect of the present invention, an infrastructure sensor system comprising a plurality of infrastructure sensors is proposed, wherein the plurality of infrastructure sensors is arranged on a shared mounting device. According to the present invention, the infrastructure sensor system according to the third aspect comprises a device according to the second aspect of the present invention.

In a preferred embodiment of the present invention, at least one of the infrastructure sensors is configured as an imaging sensor, particularly as a camera sensor, and/or as a radar sensor and/or as a lidar sensor. In other words, preferably at least one of the infrastructure sensors is configured to detect information about an environment of the infrastructure sensor system or an environment of the mounting device. This environmental information may be further processed and/or provided to road users, for example.

In a further preferred embodiment of the infrastructure sensor system of the present invention, the infrastructure sensors comprise at least one strain sensor and/or at least one accelerometer and/or at least one eddy current sensor and/or at least one travel sensor. Such sensors are typically inexpensive and small, and can directly generate data through the application of conventional measurement principles, that include information concerning an instantaneous mechanical oscillation or other motion of the mounting device, and thus permit, in a particularly efficient manner, the determination, by the sway estimation module, of a motion function for the mounting device and the ascertainment of correction information for at least one of the infrastructure sensors based on the motion function.

Such a sensor can be designed, for example, as a strain gage (e.g., as a piezoelectric surface sensor), as also to some extent used in wind turbines. By a corresponding distributed arrangement of several such strain gages, mechanical deflection or twisting of individual components of the mounting device can be specifically measured in a time-dependent manner and from this the motion function can be determined as the overall picture of the sway.

Alternatively or additionally, other sensor types, such as eddy current sensors or travel sensors, can be employed. For example, eddy current sensors are able to determine distance, path or position to metallic objects in a contactless, highly dynamic and precise manner. Even fast processes, such as vibrations or oscillations, can be accurately detected by such sensors.

Alternatively or additionally, weather sensors can be used that can detect wind speeds, for example. Alternatively or additionally, data from an online weather service can be utilized. For example, weather data such as wind speeds or temperatures can provide additional information about weather-related mechanical changes (e.g., oscillations, extension, dimensions, . . . ) of the mounting device, and thus allow for a more accurate determination of a motion function for the mounting device by the sway estimation module and/or permit a more accurate ascertainment of correction information for at least one of the infrastructure sensors based on the motion function.

### BRIEF DESCRIPTION OF THE DRAWINGS

FIGS. 1A-1C show different embodiments of mounting devices for infrastructure sensors for use in infrastructure sensor systems according to the present invention.

FIG. 2 shows an infrastructure sensor system according to a first embodiment example of the third aspect of the present invention.

FIG. 3 shows an infrastructure sensor system according to a second embodiment example of the third aspect of the present invention.

FIG. 4 shows an example of a motion function determined according to an embodiment example of a method according to the present invention.

FIG. 5 shows a flow diagram according to an embodiment example of a method according to the present invention.

FIG. 6 schematically shows the architecture of an infrastructure sensor system according to a third embodiment example of the third aspect of the present invention.

FIG. 7 schematically shows the architecture of an infrastructure sensor system according to a fourth embodiment example of the third aspect of the present invention.

FIG. 8 schematically shows a possible format for a message for exchanging information between an infrastructure sensor and the sway estimation module according to another embodiment of the present invention.

Example embodiments of the present invention are described in detail with reference to the figures.

### DETAILED DESCRIPTION OF EXAMPLE EMBODIMENTS

In the following description of the embodiment examples of the present invention, identical elements are denoted by identical reference signs, a repeated description of these elements being dispensed with, where appropriate. The figures show the subject matter of the present invention only schematically.

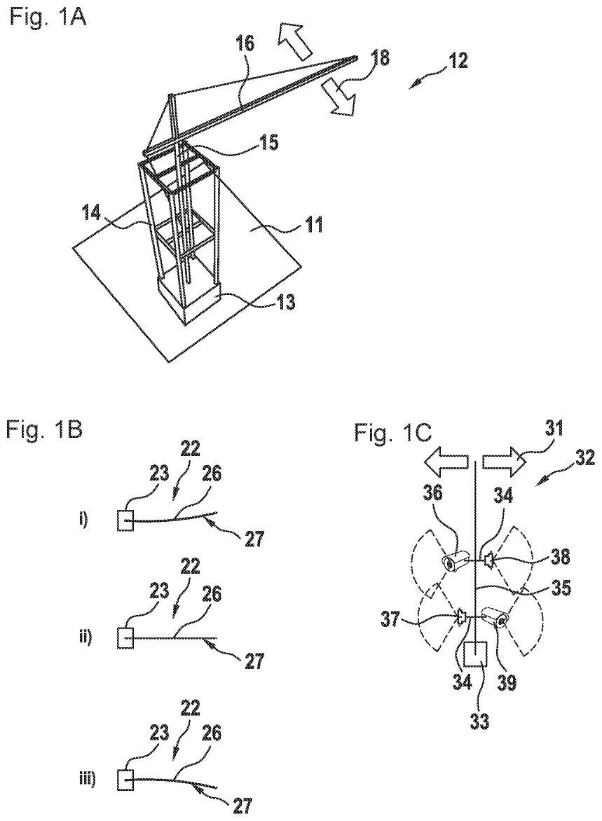

FIG. 1A shows an embodiment example of a mounting device 12 for infrastructure sensors for use in an infrastructure sensor system according to the present invention in a perspective view. The mounting device 12 includes a base 13 and a mast 15 anchored in the base that is oriented substantially perpendicular to a ground plane 11 on which the mounting device 12 stands. The mast 15 is surrounded by and connected to a support structure 14. The support structure comprises several elements aligned perpendicular and parallel to the ground plane 11 and connected to one another. The support structure 14 is configured to impart mechanical stability to the mast 15. A boom 16 is arranged on the mast 15 and extends substantially perpendicular to the mast 15 and substantially parallel to the ground plane 11. Infrastructure sensors (not shown) may be situated, that is, fastened, on the boom 16 and/or on the mast 15, which can detect, for example, the environment of the mounting device 12.

In case of strong winds, for example, or by other environmental factors, the boom 16 of the mounting device 12 can be excited to mechanical oscillations or swaying, as indicated by arrows 18.

The infrastructure sensors are typically calibrated for a specific position and orientation, which typically corresponds to a stationary boom 16. In order to be able to use the measured values of the infrastructure sensors even in case of a swaying boom 16, a method according to the first aspect of the present invention can be employed.

FIG. 1B shows an alternative configuration of a mounting device 22 for infrastructure sensors in a plan view. The mounting device 22 has a substantially vertically extending construction 23, as well as a substantially horizontally extending boom 26 arranged elevated above the ground on the construction 23. The boom 26 can be configured as a mount for several infrastructure sensors. In this example, in order to detect a swaying of the boom 26, strain sensors 27 are attached along the boom 26. In the illustration i), the boom 26 is deflected in the positive y-direction. In Figure ii), the boom 26 is in a center position or a rest position, where no correction is necessary. In Figure iii), the boom 26 is deflected in the negative y-direction. In the positions according to i) and iii) of the boom 26, there is a strain so that the strain sensors 27 provide corresponding measured values. For example, on the basis of the sign of the measured values and/or the difference of the measured values of two strain sensors, a distinction can be made between an orientation in the positive y-direction according to i) and an orientation in the negative y-direction according to iii).

In FIG. 1C, another alternative configuration of a mounting device 32 for infrastructure sensors 36, 37, 38, 39 is shown in a plan view. The mounting device 32 includes a base 33 and a mast anchored in the base that is oriented substantially perpendicular to a ground plane on which the mounting device 32 is stands (not visible in this view). The mast has a boom 35 that is substantially parallel to the ground plane. The boom 35 has two transverse struts 34 disposed in different positions along the boom 35, which are short relative to the length of the boom 35 and to each of which two infrastructure sensors 36 and 38 and 37 and 39, respectively, are attached.

For example, in case of strong winds or by other environmental factors, the boom 35 of the mounting device 32 can be excited to mechanical oscillations or swaying, as indicated by arrows 31.

Infrastructure sensors 36 and 39, in this example, are configured as camera sensors that can record images of the environment of mounting device 32 in at regular time intervals. The image data generated in this manner can be pre-processed by being evaluated, for example by optical flow analysis, and based on this evaluation, a first sway estimate can be ascertained based on which a motion function for the mounting device 32 can be calculated. Infrastructure sensors 37 and 38, in this example, are configured as radar sensors that are able to detect distances to objects in the environment of mounting device 32 with high accuracy. The thus generated object data can be additionally evaluated and/or corrected based on the calculated motion function for mounting device 32.

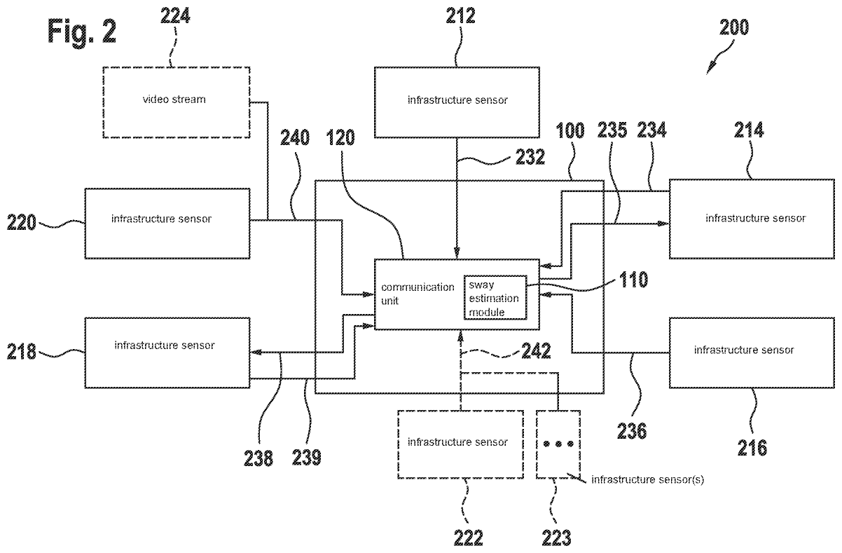

FIG. 2 shows an infrastructure sensor system 200 according to a first embodiment example of the third aspect of the present invention as a block diagram. The infrastructure sensor system 200 includes a plurality of infrastructure sensors 212, 214, 216, 218, 220, 222, 223 wherein the infrastructure sensors 212, 214, 216, 218, 220, 222, 223 are arranged on a shared mounting device (not shown). Infrastructure sensor system 200 includes a device 100 for operating infrastructure sensor system 200, comprising a sway estimation module 110 and a communication unit 120 for receiving data transmitted by infrastructure sensors 212, 214, 216, 218, 220, 222, 223. Communication unit 120 can further be configured to send information to at least one of infrastructure sensors 212, 214, 216, 218, 220, 222, 223 such that data exchange with infrastructure sensors 212, 214, 216, 218, 220, 222, 223 is enabled.

The sway estimation module 110 is configured to process the data received from the communication unit 120 and to determine a motion function therefrom for the mounting device, to ascertain correction information for at least one of the infrastructure sensors based on the motion function, and to provide the correction information and/or the motion function.

In the example of FIG. 2, the infrastructure sensors 220 and 216 are configured as camera sensors. Infrastructure sensor 216 transmits pre-processed data comprising a motion vector 236 associated with the infrastructure sensor 216 itself to the communication unit 120. The motion vector 236 was previously ascertained by the infrastructure sensor 216 itself, for example, by an analysis of the optical flow of the image data detected by the infrastructure sensor 216 and represents a first sway estimate. The motion vector 236 can indicate, for example, speed components and/or acceleration components of a motion of the infrastructure sensor 216 for all three spatial directions.

The infrastructure sensor 220 transmits pre-processed data comprising a motion vector 240 associated with the infrastructure sensor 220 itself and its own position to the communication unit 120. For example, the position of infrastructure sensor 220 can include a position determined from the motion vector and/or a position determined during an initial calibration of the infrastructure sensor 220. Alternatively or additionally, the infrastructure sensor 220 can transmit raw data, for example, in the form of a video stream 224, to the communication unit 120.

Infrastructure sensors 214 and 218 are configured as radar sensors in this example, and are representative of any sensor type that initially is not capable of performing its own sway estimate in sufficient quality. Infrastructure sensors 214 and 218 transmit their own respective positions 239, 234 to communication unit 120. For example, the infrastructure sensor's own position may be a position determined upon initial calibration of the respective infrastructure sensor 214, 218.

For example, a position of an infrastructure sensor 214, 216, 218, 220 may be represented by a global or relative coordinate. The position can additionally comprise at least one angle information (e.g., pitch angle, yaw angle, roll angle) describing an orientation of the respective infrastructure sensor 214, 216, 218, 220 and thus the detection range of the respective infrastructure sensor 214, 216, 218, 220.

The illustrated infrastructure sensor system 200 also includes an accelerometer 212 that is also arranged on the mounting device. The accelerometer 212 may be configured as a MEMS sensor, for example, and, in addition to an acceleration vector for the three spatial directions, may also detect angular accelerations and/or gravitation and/or the Earth's magnetic field and out of these generate highly accurate absolute orientation and motion information. The measurement data generated by the accelerometer 212 may be transmitted to the communication unit 120 as pre-processed data 232 and/or as raw data along with the current and/or initial position of the accelerometer 212.

Optionally, an strain sensor 222 can be provided on the mounting device or even several strain sensors 223. By means of the strain sensors 222, 223, as shown for example in FIG. 1B, a bending or deflection of an element of the mounting device can be recognized and the direction and magnitude of the bending or deflection can be detected. The strain sensors can transmit the information thus detected to the communication unit 120 in the form of raw measurement data 242, for example.

All data transmitted to the communication unit 120 are made available to the sway estimation module 110, which determines a motion function for the mounting device based on the data. Based on the motion function, the sway estimation module can determine correction information for at least one of the infrastructure sensors.

In this example, the sway estimation module 110 is configured to calculate motion vectors at least for the infrastructure sensors 214 and 218 based on the ascertained motion function for the mounting device. Such a motion vector describes the specific motion for each individual infrastructure sensor 214 and 218. For this purpose, it is necessary for infrastructure sensors 214 and 218 to communicate their own position in advance. Accordingly, based on the transmitted position of the infrastructure sensor 214 and the motion function for the mounting device, a first motion vector 235 is determined and transmitted to the infrastructure sensor 214 by the communication unit 120. Infrastructure sensor 214 can use the first motion vector 235 as correction information, for example, to correct detected environmental information or, for example, if the deviations are too large, to request recalibration. Analogously, based on the transmitted position of the infrastructure sensor 218 and the motion function for the mounting device, a second motion vector 238 can be determined and transmitted to the infrastructure sensor 218 by the communication unit 120. Infrastructure sensor 218 can utilize the second motion vector 238 as correction information.

Determining correction information for infrastructure sensors 216 and 220 configured as camera sensors is not absolutely necessary because the infrastructure sensors 216 and 220 can already perform a sway estimate by evaluating the respective detected image data, for example, by optical flow analysis. Nevertheless, it can be advantageous to calculate also a motion vector for each infrastructure sensor 216 and 220 based on a known position of the respective infrastructure sensor 216 and 220 and the motion function for the mounting device and to transmit it to the respective infrastructure sensor 216 and 220, for example, in order to check the plausibility and improve the accuracy of the sway estimates of the infrastructure sensors 216 and 220.

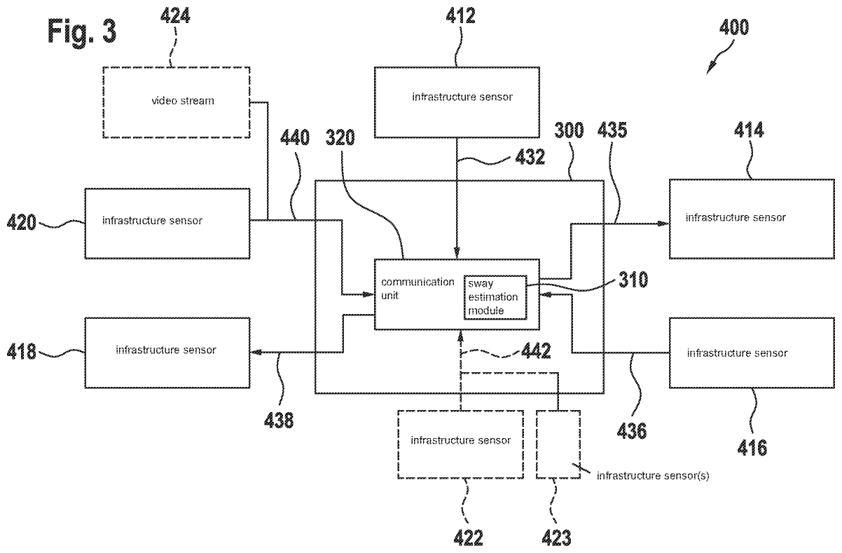

FIG. 3 shows an infrastructure sensor system 400 according to a second, alternative embodiment example of the third aspect of the present invention as a block diagram. The infrastructure sensor system 400 includes a plurality of infrastructure sensors 412, 414, 416, 418, 420, 422, 423, wherein the infrastructure sensors 412, 414, 416, 418, 420, 422, 423 are arranged on a shared mounting device (not shown). The infrastructure sensor system 400 includes a device 300 for operating the infrastructure sensor system 400, comprising a sway estimation module 310 and a communication unit 320 configured to receive data transmitted from the infrastructure sensors 412, 414, 416, 418, 420, 422, 423.

The sway estimation module 310 is configured to process the data received from the communication unit 320 and to determine a motion function for the mounting device therefrom, to ascertain correction information for at least one of the infrastructure sensors based on the motion function, and to provide the correction information and/or the motion function.

In the example of FIG. 3, the infrastructure sensors 420 and 416 are configured as camera sensors and the infrastructure sensors 414 and 418 are configured as radar sensors. Furthermore, one or more strain sensors 433, 423 and at least one inertial sensor 412 are provided.

As in the example of FIG. 2, the inertial sensor 412 transmits its position and measurement data 432 that characterize at least one motion and/or acceleration of the mounting device to the communication unit 320. The camera sensors 416 and 420 each transmit their own position and a first sway estimate 436 and 440 determined by the respective camera sensor 416 and 420, respectively, to the communication unit 320, for example in the form of a motion vector. Alternatively or additionally, the camera sensors 416 and 420 can transmit raw data, for example, in the form of a video stream, to the communication unit 320. The strain sensors 422, 423 transmit raw data, which, for example, denote a deflection of an element of the mounting device in a specific spatial direction, to the communication unit 320.

All data transmitted to the communication unit 320 are made available to the sway estimation module 310, which determines a motion function for the mounting device based on the data. Based on the motion function, the sway estimation module can ascertain correction information for at least one of the infrastructure sensors.

As a result 435, 438, in this example, the motion function is passed on to infrastructure sensors 414 and 418 that do not have a sway estimation of their own. Subsequently, infrastructure sensors 414 and 418 can determine their current motion vector using the motion function and their initially calibrated position. Alternatively or additionally (not shown here), the result can also be distributed to infrastructure sensors 416 and 420 to improve or overwrite their in-sensor sway estimate. The advantage of this variant is that the motion function is not dependent on the respective sensor position and can therefore be distributed equally to all infrastructure sensors. By using multicast/broadcast mechanisms in IP-based networks, the network load can be kept small.

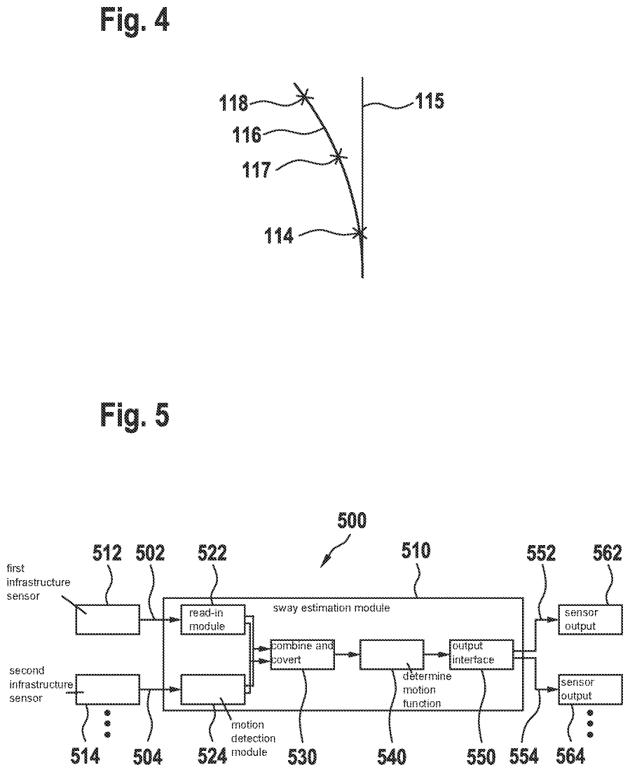

The difference between the two variants according to FIGS. 2 and 3 is shown again separately in FIG. 4. The vertical line 115 illustrates a mast of an mounting device at rest without external influences. The line 116 describes the deformation of the mast at a specific point in time and thus represents the motion function. Positions 114, 117, and 118 are exemplary sensor positions that have changed according to the motion function or a motion vector based on the motion function for the respective sensor rest position.

A flowchart 500 of an example of a sway estimation module 510 (as a hardware or software component) employed in a device configured according to an embodiment example of the present invention is shown in FIG. 5. As input, two infrastructure sensors 512 and 514 are illustrated here by way of example. The relevant infrastructure sensor system, in which the illustrated sway estimation module 510 is used, can additionally have further sensors. The first infrastructure sensor 512 provides as output 502 pre-processed data that already include a first sway estimate, e.g., in the form of a current position and a motion vector and/or in the form of extrinsic calibration parameters.

The second infrastructure sensor 514 provides a raw data signal as output 504. The pre-processed data 502 can be easily read in by a read-in module 522. The raw data 504 are post-processed by a motion detection module 524, e.g., by optical flow analysis. Subsequently, information obtained from the transmitted data of sensors 512 and 514 is combined in module 530 and converted into a common representation, if necessary, such as a common local coordinate system. Thereafter, a motion function is ascertained in module 540 with the information thus combined. The motion function can be characterized for example by various functional parameters. The motion function, or data determining the motion function, are passed on to an output interface 550. The output interface 550 generates data 552, 554, which are specific to the sensors 512, 514 and are transmitted as sensor outputs 562, 564 to the respective sensor 512, 514 and/or other sensors of the infrastructure sensor system. For example, a motion function 554 is passed on, which is transmitted as output 564 to the sensor 514 and/or other sensors of the infrastructure sensor system and by which a receiving sensor can specify its current position and/or motion. Using a known sensor position of the sensor 512 and/or of another sensor of the infrastructure sensor system, a specific motion vector 552 for the sensor 512 or for another sensor of the infrastructure sensor system can be determined and transmitted as output 562 to the respective sensor 512.

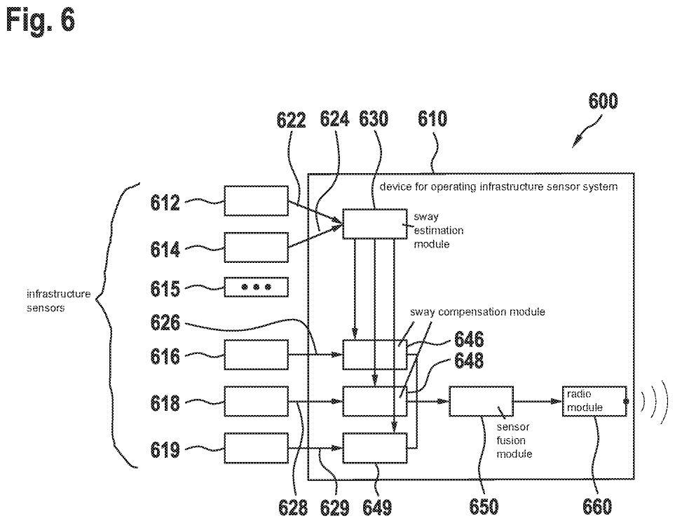

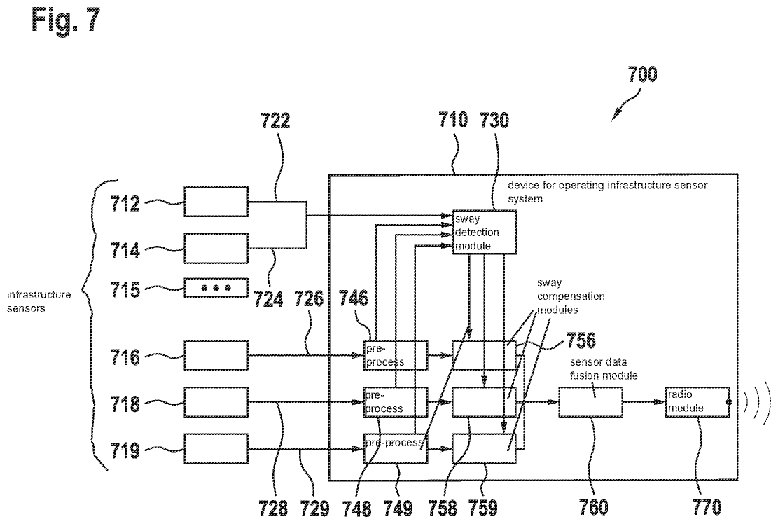

Architectural diagrams of infrastructure sensor systems 600 and 700 are shown in FIGS. 6 and 7, respectively. In these two embodiment examples, the correction information is not fed back into the infrastructure sensors, but rather flows into the post-processing of the environmental information detected by the infrastructure sensors of the respective infrastructure sensor system 600 and 700. In this way, the infrastructure sensors involved do not have to be compatible with the sensor sway detection and, for example, older or conventional sensors can also be used and their measurement data quality can be improved.

FIG. 6 shows an infrastructure sensor system 600 having a plurality of infrastructure sensors 612, 614, 615, 616, 618, 619 arranged on a shared mounting device (not shown), for example, according to FIG. 1, and which transmits data 622, 624, 626, 628, 629 to a device 610 for operating the infrastructure sensor system 600. The data are in this case received and further distributed by a communication unit (not shown). The device 610 in this example is configured as a computing unit comprising various modules (hardware and/or software) for further processing of the transmitted data. The device 610, for example, can be part of a so-called roadside unit (RSU), that is, an infrastructure-side computer system arranged in spatial proximity of the mounting device with the infrastructure sensors 612, 614, 615, 616, 618, 619 and configured to receive and further process data generated by the infrastructure sensors 612, 614, 615, 616, 618, 619, and to make the further processed data available, for example, to networked vehicles. Alternatively, the device 610 can be configured as part of a cloud system.

Infrastructure sensor system 600 includes infrastructure sensors 616, 618, and 619 that are configured as environmental sensors. In the example shown, the infrastructure sensor 616 is configured as a camera, the infrastructure sensor 618 is configured as a radar sensor, and the infrastructure sensor 619 is configured as a LIDAR sensor. The use of other or additional types of environmental sensors is possible. Infrastructure sensors 616, 618 and 619 are configured to detect their environment and to generate, from the detected environmental data, object lists that include characteristics, e.g., position, speed, acceleration, object size, object type, . . . of moving and/or stationary objects in the environment of the respective sensor. Infrastructure sensors 616, 618, and 619 each transmit such lists of objects as pre-processed data 626, 628, 629 to device 610 for further processing and evaluation.

Infrastructure sensor system 600 further includes infrastructure sensors 612, 614, 615 configured to detect a sway of the mounting device. In this case, the infrastructure sensor 612 is configured as an strain sensor, in particular as strain gage, and provides a measurement signal when a strain of a mechanical element of the mounting device occurs. The infrastructure sensor 614 is configured as an inertial sensor or accelerometer and is able to detect a motion for example, in particular an acceleration, of a mechanical element of the mounting device and output a corresponding measurement signal. Infrastructure sensor system 600 can include several strain sensors and/or accelerometers 615. Infrastructure sensors 612, 614, 615 transmit data 622, 624 as raw measurement data and/or as pre-processed motion and/or strain information to the device 610 for further processing and/or evaluation. The data 622, 624 transmitted by the infrastructure sensors 612, 614, 615 are fed to a sway estimation module 630 of the device 610 that processes the data 622, 624 and determines from this a motion function for the mounting device and/or provides correction information for the infrastructure sensors 616, 618, and 619 based on the motion function and provides the correction information and/or the motion function for sway compensation. The object lists transmitted from the infrastructure sensors 616, 618 and 619 are now corrected in a sensor-specific manner using the correction information and/or motion function provided to a respective sway compensation module 646, 648, 649 of the device 610, that is, the object properties included in the object lists are adjusted using the provided correction information and/or the motion function in such a way that this results in corrected object properties, for example corrected positions, speeds, accelerations, . . . of the objects in the object lists. The thus corrected object lists are fed to a sensor fusion module 650 that creates an environmental model based on the corrected object lists. The environmental model can be provided, e.g., to networked vehicles or other road users by way of a radio module 660.

In the example shown, infrastructure sensors 616, 618, and 619 can each already perform their own, first sway detection based on the data they themselves collect and can transmit the result to the sway detection module 630, which can take it into account in determining the motion function. In this case, it should be ensured that the infrastructure sensors 616, 618 and 619 do not already perform any additional sway compensation internally as the compensation steps can otherwise interfere with each other.

In FIG. 7, sensors without pre-processing are illustrated, by way of example, which provide raw data for example (e.g., video stream) and/or feature data (e.g., prominent lines, points, . . . ). These data must first be processed in the infrastructure system, for example, as a detection and tracking of objects. In addition, prominent points can be detected or read in and also fed into the sway detection.

FIG. 7 illustrates an infrastructure sensor system 700 having a plurality of infrastructure sensors 712, 714, 715, 716, 718, 719 disposed on a shared mounting device (not shown), for example, according to FIGS. 1A-1C, and respectively transmitting data 722, 724, 726, 728, 729 to a device 710 for operating the infrastructure sensor system 700. The data are received and further distributed by a communication unit (not shown). In this example, the device 710 is configured as a computing unit comprising various modules (hardware and/or software) for further processing the transmitted data.

The infrastructure sensor system 700 includes infrastructure sensors 716, 718, and 719 that are configured as environmental sensors. In the example shown, the infrastructure sensor 716 is configured as a camera, the infrastructure sensor 718 is configured as a radar sensor, and the infrastructure sensor 719 is configured as a LIDAR sensor. Infrastructure sensors 716, 718, and 719 are configured to detect their environment by, for example, recording image data of the environment, or measuring distances to objects in the environment. Infrastructure sensors 716, 718 and 719 can be configured to extract specific prominent environmental features from the detected raw data, for example, fixed structures such as guardrails or walls. Infrastructure sensors 716, 718, 719 transmit as data 726, 728, 729 respectively raw measurement data and/or, in the case of camera sensor 716, video stream data and/or information about detected prominent environmental characteristics (“feature data”) to the device 710 for further processing and/or evaluation. For each of the infrastructure sensors 716, 718, 719, the device 710 includes a pre-processing module 746, 748, 749. In the pre-processing module 746, the data 726 transmitted by the camera sensor 716 are processed, for example, by methods of digital image processing. In the process, in particular objects can be recognized and tracked. In the pre-processing module 748, the data 728 transmitted by the radar sensor 718 are processed, for example, by determining object distances and/or relative velocities from transmitted raw data. If the data 728 additionally or alternatively include feature data, the features can be associated with known features. In the pre-processing module 749, the data 729 transmitted by the LIDAR sensor 719 are processed, for example, by determining object distances from transmitted raw data. Thus, for each of the infrastructure sensors 716, 718, 719, pre-processed data are obtained that are provided to a sway detection module 730.

Optionally, the infrastructure sensor system 700 further includes infrastructure sensors 712, 714, 715 configured to detect a sway of the mounting device. The infrastructure sensor 712 is here configured as a strain sensor, in particular as a strain gage, and provides a measurement signal when a strain of a mechanical element of the mounting device occurs. The infrastructure sensor 714 is configured as an inertial sensor or accelerometer and can detect, for example, a motion, in particular an acceleration, of a mechanical element of the mounting device and output a corresponding measurement signal. Infrastructure sensor system 700 can include several strain sensors and/or accelerometers 715. Infrastructure sensors 712, 714, 715 transmit data 722, 724 as raw measurement data and/or as pre-processed motion and/or strain information to the device 610 for further processing and/or evaluation. The data 722, 724 transmitted by the infrastructure sensors 712, 714, 715 are provided to the sway estimation module 730 of the device 710.

The sway estimation module 730 can now determine from the optional data of infrastructure sensors 712, 714, 715 and from the data provided by pre-processing modules 746, 748, 749 a motion function for the mounting device, and/or ascertain correction information for infrastructure sensors 716, 718, and 719 based on the motion function, and provide the correction information and/or the motion function for sway compensation. In respective sway compensation modules 756, 758, and 759, the pre-processed data of infrastructure sensors 716, 718, and 719 can now be corrected for swaying of the shared mounting device. The thus corrected data, which can include, for example, object information, are fed to a sensor data fusion module 760 that creates an environment model based on the corrected data. The environmental model can be provided by means of a radio module 770, e.g., to networked vehicles or other road users.

In both the example shown in FIG. 6 as well as in the example shown in FIG. 7, the result of the sway detection must be applied to the pre-processed data streams of each individual infrastructure sensor 616, 618, 619, and 716, 718, 719, respectively, so that all pieces of object information in the sensor data fusion refer to the same coordinate system. In the sway compensation, individual sensors of infrastructure sensors 616, 618, 619, and 716, 718, 719, respectively, can also be excluded or assigned a lesser confidence or weight if specific thresholds of swaying have been exceeded.

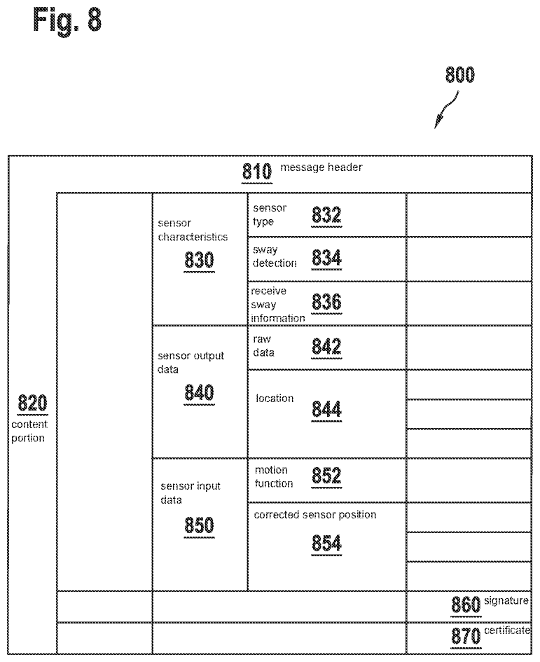

FIG. 8 schematically shows a data format for a message 800 for exchanging information between an infrastructure sensor and the sway estimation module according to a possible embodiment of the present invention. The message 800 here includes the data transmitted from the sensor to the infrastructure sensor system and the correction information and/or motion function sent from the infrastructure sensor system to a sensor. The message 800 includes a message header 810 for this purpose. Furthermore, the message 800 includes a content portion 820. The content portion 820 includes a first data block 830 comprising sensor characteristics. In this example, the sensor characteristics include information about the sensor type 832 (e.g., camera/IMU/radar/lidar/ . . . ), the information 834 whether the sensor itself has sway detection, and the information 836 whether the sensor would like to receive sway information (e.g., a motion function) or not. The content portion 820 includes a second data block 840 comprising sensor output data, for example, directly the raw data 842 (e.g., pixel values in the case of a video sensor or point clouds in the case of a radar/LIDAR point clouds) or a link to the data, e.g., by a link to a RTSP stream (Real-Time Streaming Protocol) by which the video stream of the camera can be retrieved. Furthermore, the sensor output data can include a position 844, e.g., in the form of coordinates in a defined coordinate system and/or a motion vector and/or a sensor alignment or sensor orientation (yaw angle, pitch angle, roll angle). The content portion 820 comprises a third data block 850 comprising sensor input data, for example a motion function 852 and/or a corrected sensor position 854 and/or a corrected motion vector and/or a corrected sensor alignment or sensor orientation (yaw angle, pitch angle, roll angle). The message 800 further optionally includes a signature 860 and further optionally a certificate 870 for validating the signature.

What is claimed is:

1. A method for operating an infrastructure sensor system, wherein the infrastructure sensor system has a plurality of infrastructure sensors arranged on a shared mounting device, the method comprising the following steps:
transmitting data by each respective infrastructure sensor of at least one of the infrastructure sensors to a sway estimation module, wherein the data include:
pre-processed data including environmental information determined by the respective infrastructure sensor, and/or
current measurement data including raw data detected by the respective infrastructure sensor;
processing the transmitted data, and determining from the processed transmitted data, using the sway estimation module, a motion function for the mounting device;
ascertaining, using the sway estimation module, correction information based on the motion function; and
providing the correction information and/or the motion function.

2. The method according to claim 1, wherein the pre-processed data include a position of the respective infrastructure sensor and/or an orientation of the respective infrastructure sensor and/or a motion vector according to a previously performed calibration of the respective infrastructure sensor and/or measurement data of the respective infrastructure sensor.

3. The method according to claim 1, wherein at least one of the infrastructure sensors of the infrastructure sensor system is configured as an environment sensor including an imaging sensor, and the transmitted data include a first sway estimate which is ascertained using environmental information detected by the environment sensor, wherein the first sway estimate is provided to the sway estimation module and is used in determining the motion function and/or in ascertaining the correction information.

4. The method according to claim 3, wherein the processing of the data and the determining of the motion function for the mounting device is performed by the sway estimation module, additionally as a function of the first sway estimation.

5. The method according to claim 3, wherein the environmental information includes raw data, wherein the sway estimation module determines, based on the raw data, the first sway estimate and/or a second sway estimate, wherein the determination of the motion function for the mounting device is performed by the sway estimation module, additionally as a function the first sway estimate and/or of the second sway estimate.

6. The method according to claim 3, wherein the first sway estimate is determined by optical flow analysis of image data detected by an infrastructure sensor configured as an imaging sensor.

7. The method according to claim 3, wherein the first sway estimate is determined by an analysis of landmarks or point clouds in comparison to a map, which were detected by an infrastructure sensor configured as an imaging sensor.

8. The method according to claim 1, wherein the environmental information includes object features of objects in the environment of the infrastructure sensor system, wherein the object features are provided to the sway estimation module and are used in determining the motion function and/or in ascertaining the correction information.

9. The method according to claim 1, wherein the correction information includes functional parameters of the motion function, wherein using the functional parameters of the motion function, an updated position and orientation and/or a motion vector for at least one of the infrastructure is determined.

10. The method according to claim 1, wherein sensor-specific motion vectors are determined as the correction information, wherein using a sensor-specific motion vector, an updated position and/or orientation for at least one of the infrastructure sensors is determined.

11. The method according to claim 1, wherein the correction information is transmitted to at least one of the infrastructure sensors of the infrastructure sensor system so that measurement data of the at least one of the infrastructure sensors can be corrected using the correction information and/or can subsequently be marked as inaccurate.

12. The method according to claim 1, wherein the correction information is transmitted to a computing unit and measurement data and/or environmental information are transmitted from the infrastructure sensors to the computing unit, wherein the computing unit calculates an environmental model of the infrastructure sensor system using the correction information and the measurement data and/or environmental information.

13. The method according to claim 1, wherein:
for information exchange between each infrastructure sensor and the sway estimation module, a message is used, which includes the data and the correction information, wherein the correction information includes motion function and/or parameters of the motion function and/or a sensor-specific motion vector and/or a corrected sensor position and/or a corrected sensor orientation;
the message includes information relating to the infrastructure sensor including a sensor type of the infrastructure sensor and/or information as to whether the infrastructure sensor has its own sway detection and/or information as to whether the infrastructure sensor requires the correction information.

14. The method according to claim 13, wherein the message further includes a signature and further optionally a certificate for validating the signature.

15. A device for operating an infrastructure sensor system, comprising:
a sway estimation module; and
a communication unit, which is used to receive data, the data including pre-processed data including environmental information and/or current measurement data including raw data, from infrastructure sensors of the infrastructure sensor system, wherein the infrastructure sensors are arranged on a shared mounting device;
wherein the sway estimation module is configured to process the data received by the communication unit and to determine therefrom a motion function for the mounting device, to ascertain correction information based on the motion function, and to provide the correction information and/or the motion function.

16. An infrastructure sensor system, comprising:
a plurality of infrastructure sensors arranged on a shared mounting device; and
a device for operating an infrastructure sensor system, including:
a sway estimation module, and
a communication unit, which is used to receive data, the data including pre-processed data including environmental information and/or current measurement data including raw data, from the infrastructure sensors;
wherein the sway estimation module is configured to process the data received by the communication unit and to determine therefrom a motion function for the mounting device, to ascertain correction information based on the motion function, and to provide the correction information and/or the motion function.

17. The infrastructure sensor system according to claim 16, wherein at least one of the infrastructure sensors is configured as an imaging sensor including a camera sensor, and/or as a radar sensor and/or as a lidar sensor.

18. The infrastructure sensor system according to claim 16, wherein the infrastructure sensors include at least one strain sensor and/or at least one accelerometer and/or at least one eddy current sensor and/or at least one travel sensor.
